(19) United States
(12) Patent Application Publication
(10) Pub. No.: US 2012/0092300 A1
(43) Pub. Date: Apr. 19, 2012

(54) VIRTUAL TOUCH SYSTEM

(75) Inventors: Hau-Wei Wang, Taipei County (TW); Fu-Cheng Yang, Hsinchu County (TW); Chun-Chieh Wang, Taoyuan County (TW); Shu-Ping Dong, Taichung County (TW)

(73) Assignee: INDUSTRIAL TECHNOLOGY RESEARCH INSTITUTE, Hsinchu (TW)

(21) Appl. No.: 12/981,492

(22) Filed: Dec. 30, 2010

(30) Foreign Application Priority Data
Oct. 18, 2010 (TW) 99135513

(51) Int. Cl. G06F 3/042

(52) U.S. Cl. 345/175

(57) ABSTRACT

A virtual touch system including a head-mounted see-through display device, a micro-image display, at least two micro image-capturing devices, and an image processing unit is provided. The head-mounted see-through display device has a holder and an optical lens group that allows an image light of a real scene to directly pass through and reach an observing location. The micro-image display disposed on the holder of the head-mounted see-through display device casts a display image to the observing location through the optical lens group to generate a virtual image plane, wherein the virtual image plane contains a digital information. The micro image-capturing devices disposed at the holder capture images of the real scene and a touch indicator. The image processing unit coupled to the head-mounted see-through display device recognizes the touch indicator and calculates a relative location of the touch indicator on the virtual image plane for the micro-image display.

### CROSS-REFERENCE TO RELATED APPLICATION

This application claims the priority benefit of Taiwan application serial no. 99135513, filed on Oct. 18, 2010. The entirety of the above-mentioned patent application is hereby incorporated by reference herein and made a part of this specification.

### BACKGROUND OF THE INVENTION

1. Technical Field

The disclosure relates to a virtual touch system for virtual touch operations within a region of interest.

2. Background

A cell phone or a notebook computer performs as a portable information platform by offering communication, audio/video playing, web browsing, navigation, storage, and notebook functions. However, such a usual portable information platform may have its limitations. For example, cell phones have very compact screens and keyboards therefore are not convenient to be used for data browsing and input, and notebook computers are less portable due to the weight thereof and the reliance to desktop support. None of the usual portable information platform techniques provides large screen, input convenience, and high portability at the same time. In addition, the information in usual cell phone or notebook computer is not integrated with actual objective images. For example, when a navigation, translation, image (or video) capturing, or human face recognition function is used, because the information and the object have different fields of vision, the user's eyes need to switch between the object (road, book, or people) and the device, which may result in safety issues and inconveniences. Moreover, the expandability of such a portable information platform is restricted by the structure thereof.

In addition, the information in usual cell phone or notebook computer is not integrated with actual objective images. For example, when a navigation, translation, image (or video) capturing, or human face recognition function is used, because the information and the object have different fields of vision, the user's eyes need to switch between the object (road, book, or people) and the device, which may result in safety issues and inconveniences. Moreover, the expandability of such a portable information platform is restricted by the structure thereof.

In recent years, manufacturers of cell phones, computers, and display devices and suppliers of Internet search engines have been working very hard on the development of new portable input/output (I/O) techniques from different angles, and each of them pictures a scene of smart mobile display in the future, wherein visual platform is the most outstanding one. When all services are hosted as cloud services, the front-end hardware and operating systems (OS), regardless of personal computers (PC), notebook computers, or smart phones, are all simplified and the operations are moved to the back end. It's like everyone has a virtual super computer with a thin client connection in service mode. That means the PCs, notebook computers, and Smart Phones in the future will not be the same as what we see today. Thus, how to meet the requirements of consumers in the cloud computing era is one of the major subjects in today's research and development programs.

A conventional technique allows a real scene and a displayed micro-image to be viewed at the same time through a head-mounted see-through display device in response to the image processing of a portable information platform, and which is also referred to as a see-through display technique. FIG. 1 is a diagram illustrating the mechanism of the see-through display technique. Referring to FIG. 1, a reflective surface 102 and a reflective surface 104 are respectively disposed at two ends of a transmissive substrate 100. Image light emitted by a micro-image display 106 is reflected by the reflective surface 102 to the reflective surface 104 and then reflected by the reflective surface 104 into a human eye 108. Thus, the human eye 108 can see the real scene in front and the image displayed in the micro-image display 106 at the same time.

The function of a head-mounted see-through display device can be achieved if the transmissive substrate 100 is designed as a head-mounted see-through display device.

### SUMMARY

A micro personalized visual interaction platform is introduced herein, wherein a head-mounted portable input/output (I/O) platform could be integrated with a real scene, so that virtual touch operations can be accomplished to provide desired information.

According to an embodiment of the disclosure, a virtual touch system including a see-through display device, a micro-image display, at least two micro image-capturing devices, and an image processing unit is provided. The see-through display device has a holder and an optical lens group that allows an image light of a real scene to directly pass through and reach an observing location. The micro-image display is disposed on the holder. The micro-image display casts a display image to the observing location through the optical lens group to generate a virtual image plane, wherein the virtual image plane includes digital information. The micro image-capturing devices are disposed at the holder for capturing images of the real scene and a touch indicator. The image processing unit is coupled to the see-through display device. The image processing unit recognizes the touch indicator and calculates a relative location of the touch indicator on the virtual image plane for the micro-image display.

According to an embodiment of the disclosure, a virtual touch system including a head-mounted see-through display device, a micro-image display, at least two micro image-capturing devices, and an image processing unit is provided. The head-mounted see-through display device has a holder and an optical lens group. The micro-image display is disposed on the holder. The micro-image display casts a display image to an observing location through the head-mounted see-through display device to generate a virtual image plane, wherein the virtual image plane includes touch control digital information. The micro image-capturing devices are disposed at the holder for capturing images of a touch indicator. The image processing unit is coupled to the head-mounted see-through display device. The image processing unit recognizes the touch indicator and calculates a relative location of the touch indicator on the virtual image plane for the micro-image display, so as to display the touch control digital information.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a diagram illustrating the mechanism of a see-through display technique.

FIG. 2 is a system diagram of a head-mounted see-through display device adopting a see-through display technique according to an embodiment of the disclosure.

FIG. 3 is a diagram illustrating an image captured by human eyes according to an embodiment of the disclosure.

FIG. 4 is a diagram illustrating the structure of a head-mounted see-through display device with stereoscopic visual localization according to an embodiment of the disclosure.

FIG. 5 is a diagram illustrating a touch operation for integrating a real scene on a virtual image plane according to an embodiment of the disclosure.

FIG. 6 is a diagram illustrating virtual operations of a virtual touch system according to an embodiment of the disclosure.

FIG. 7 is a diagram of a virtual touch system according to an embodiment of the disclosure.

FIG. 8 is a diagram illustrating the mechanism of estimating a touch location by two micro image-capturing devices from an image plane according to an embodiment of the disclosure.

FIG. 9 is a diagram illustrating an effective operation range of long-distance touch operations according to an embodiment of the disclosure.

FIG. 10 is a diagram illustrating an effective operation range of short-distance touch operations according to an embodiment of the disclosure.

FIG. 11 is a diagram illustrating the structure of a head-mounted portable input/output (I/O) embedded platform according to an embodiment of the disclosure.

FIG. 12 is a diagram illustrating a dynamic real-virtual control procedure according to an embodiment of the disclosure.

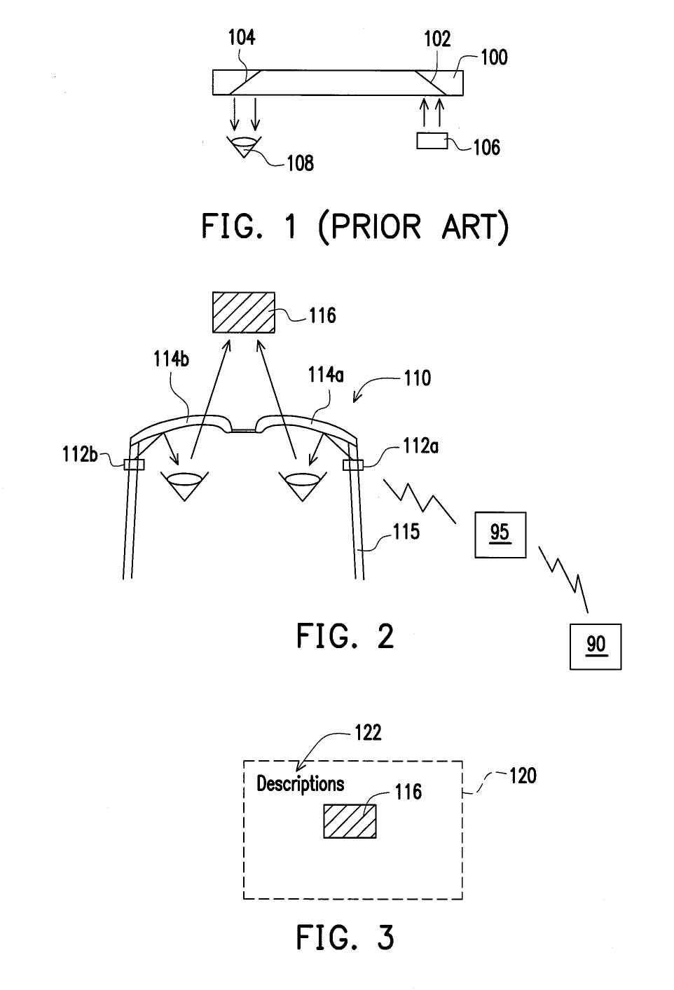

### DETAILED DESCRIPTION OF DISCLOSED EMBODIMENTS

The disclosure provides a complete portable input/output (I/O) platform adopting a see-through display technique and a stereoscopic visual localization technique. This portable I/O platform allows a user to view a real scene and electronic information image at the same time, can integrate electronic information with images of the real scene, allow the user to input in an unsupported manner, and can be carried around and used anywhere, and the digital services thereof can be extended. An embodiment of the disclosure resolves at least the issues of small screen and inconvenient input in an existing cell phone or computer. Besides, the disclosure also provides more development platforms by adopting an augmented reality (AR) technique and a suitable visual platform for the AR technique, so that the interactivity of the AR technique is improved.

Below, embodiments of the disclosure will be described. However, these embodiments are not intended to limit the scope of the disclosure and may be combined appropriately.

The disclosure provides a see-through display device based on the see-through display technique. FIG. 2 is a system diagram of a head-mounted see-through display device adopting a see-through display technique according to an embodiment of the disclosure. Referring to FIG. 2, the see-through display technique is implemented in a head-mounted see-through display device. The head-mounted see-through display device is not limited to a specific type, and which may be any head-mounted see-through display device, such as a pair of goggles. The see-through display device 110 includes optical lens groups 114a and 114b and a holder 115. One or two micro display 112a or 112b is disposed on the holder 115. Herein if two micro displays 112a and 112b are disposed, the two micro displays 112a and 112b may display same images to present a 2D image or images with parallax to present a 3D image. If one micro display is disposed, the image displayed is received by both eyes of a user. The images displayed by the micro displays 112a and 112b are cast to the user's eyes through the reflective structure of the optical lens groups 114a and 114b or a combined refraction/reflection/diffraction structure, such as (1) refractive structure; (2) reflective structure; (3) diffractive structure; (4) refractive and reflective structure; (5) refractive and diffractive structure; (6) reflective and diffractive structure; (7) refractive, reflective, and diffractive structure. Thereby, the user's eyes can see a real object 116 and images displayed by the micro displays 112a and 112b at the same time.

Digital information may be provided to the micro displays 112a and 112b to be displayed by connecting a mobile electronic device 95 to a network 90.

FIG. 3 is a diagram illustrating an image captured by human eyes according to an embodiment of the disclosure. Referring to FIG. 3, an image observed by the eyes of a user includes information of the real object 116 and descriptions 122 displayed by the micro displays on a virtual display plane 120 within the user's eyes. The descriptions 122 may be description information related to the real object 116 provided by the network 90.

However, the head-mounted see-through display device described above should come with a touch input system such that the dynamic content displayed on the virtual display plane 120 can be conveniently controlled. To accomplish touch operations, the location of a touch indicator should be detected, and along with the virtual touch function on the virtual display plane 120, the performance of the entire system can be improved.

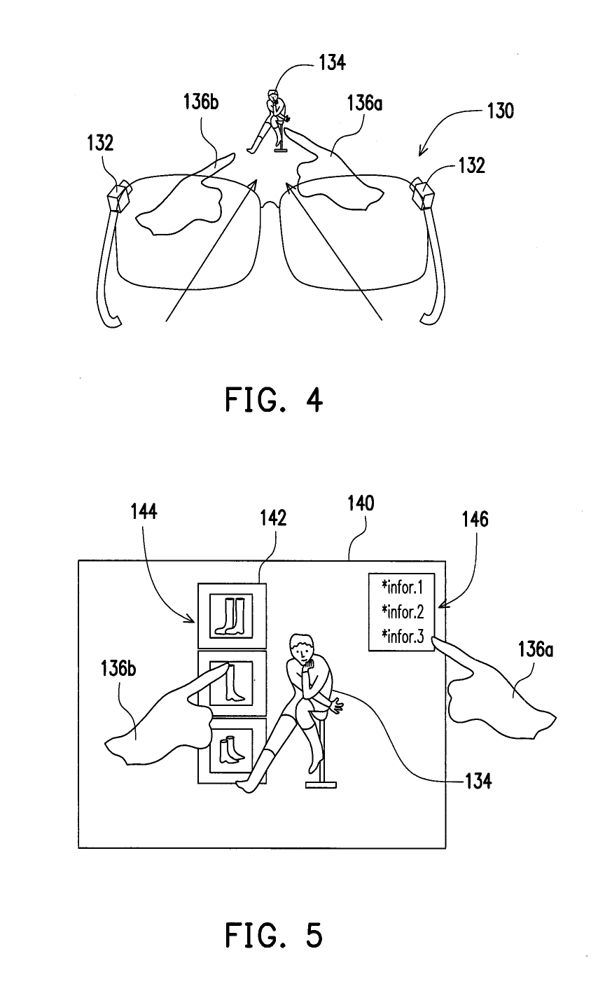

FIG. 4 is a diagram illustrating the structure of a head-mounted see-through display device with stereoscopic visual localization according to an embodiment of the disclosure. Referring to FIG. 4, a user can directly see a real scene 134, such as a person in a pair of riding boots, by using a head-mounted see-through display device 130 with a stereoscopic visual localization function. At least two micro image-capturing devices 132 are disposed at two ends of the head-mounted see-through display device 130. A stereoscopic visual localization device can be constituted by using two (or more) micro image-capturing devices. The stereoscopic visual localization device is not limited to be disposed on the holder, and it can be disposed anywhere around the head-mounted see-through display device as long as the condition of stereoscopic visual localization is met. The micro image-capturing devices 132 may be micro cameras or other image capturing devices. Herein the micro image-capturing devices 132 are connected with the micro displays 112a and 112b therefore can transmit data back and forth with the network 90. The micro image-capturing devices 132 can capture images of touch tools 136a and 136b. The micro image-capturing devices 132 recognize the touch indicators of the touch tools 136a and 136b through an image processing unit, wherein the touch tools 136a and 136b may be fingers, and the finger tips are served as the touch indicator. The image processing unit further calculates a relative location of the touch indicator on a virtual image plane for the micro-image displays 12a and 112b. Thus, the system gets to know which location on the virtual image plane is touched and responds to the touch operation accordingly.

FIG. 5 is a diagram illustrating a touch operation for integrating a real scene on a virtual image plane according to an embodiment of the disclosure. Referring to FIG. 5, after images of a real scene 134 are captured by the micro image-capturing devices 132, related digital information provided by a network is displayed by the micro displays 112a and 112b, and a virtual image plane 140 is formed after the displayed image is cast into the eyes of a user. The real scene 134 is captured by the user's eyes at the same time and accordingly a visual image is produced. Herein description information 144 and 146 of the real scene 134 is displayed on the virtual image plane 140, and there may be lower-level information (for example, type information of the riding boots) in the description information 144 and 146 that can be selected through virtual touch operations. The description information 144 may have a touch pattern 142. Moreover, the touch operations may be carried out by using a virtual keyboard. Virtual touch operations can be carried out in a non-physical space by detecting the touch locations of the touch tools 136a and 136b. In other words, the physical mouse, keyboard, and touch screen can be operated virtually without touching them by using any physical object.

How the location of the touch indicator (for example, the location of the finger tips) of the touch tools 136a and 136b is obtained will be described later on. Whether a touch operation is triggered by a specific action or through other mechanisms when a finger tip reaches an option is not limited herein.

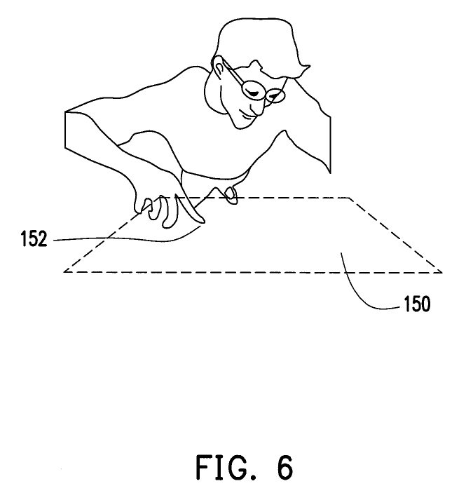

FIG. 6 is a diagram illustrating virtual operations of a virtual touch system according to an embodiment of the disclosure. Referring to FIG. 6, when a user wears the head-mounted see-through display device in the disclosure, the user may perform a touch operation on a virtual image plane 150 by using a finger 152. Besides being a clicking operation within a touch area, the touch operation may also be a continuous movement on the virtual image plane 150 (for example, for drawing a picture). The virtual image plane 150 may have a white background. In other words, the virtual image plane 150 may work with a remote computer host (i.e., the virtual image plane 150 is a virtual screen of the computer system). The application of the head-mounted see-through display device provided by the disclosure is not limited to foregoing embodiments, and which may be applied in different suitable environments by connecting to a remote computer system.

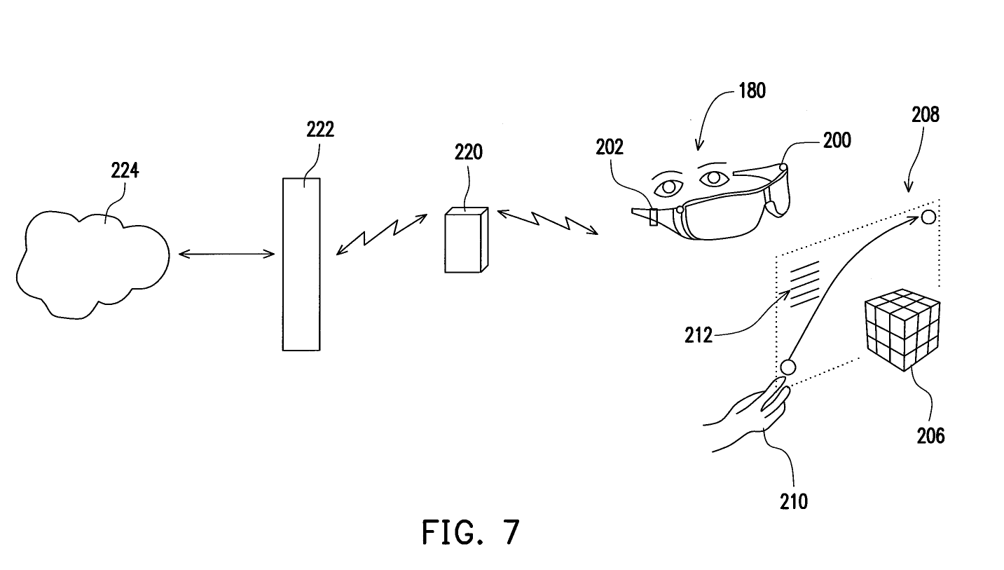

FIG. 7 is a diagram of a virtual touch system according to an embodiment of the disclosure. Referring to FIG. 7, in the head-mounted see-through display device 180 with see-through display and touch indicator detection functions, a micro displays 202 is disposed on the holder thereof. An image displayed by the micro displays 202 is cast into the eyes of a user through the structure of the head-mounted see-through display device (for example, with the structure of the optical lens group), so that a digital information 212 is visually displayed on the virtual image plane 208, and the user's eyes can see a real scene 206. Namely, the virtual image plane 208 and the real scene 206 are both presented visually.

A plurality of micro image-capturing devices 200 is further disposed on the holder, and these micro image-capturing devices 200 are configured to capture images of the real scene 206 and a touch tool 210 (for example, a finger). The images captured by the micro image-capturing devices 200 and the micro displays 202 are connected to the Internet 222 through a mobile electronic product 220, and the location of the finger tip on the virtual image plane 208 is detected through an image processing function of a remote processing unit 224, so that the touch operation of the touch tool 210 can be detected, wherein whether the touch operation is a click operation for displaying the digital information 212 and whether the touch tool 210 is dragged can be determined. However, the image processing may not be carried out by the remote processing unit 224 completely. Instead, part of the image processing function may be integrated on the holder. The processing unit possesses various functions for image recognition and analysis. The location on the micro displays 202 corresponding to that on the virtual image plane 208 can be obtained through coordinate system conversion of the micro image-capturing devices 200 and the micro displays 202, so that touch operations can be carried out.

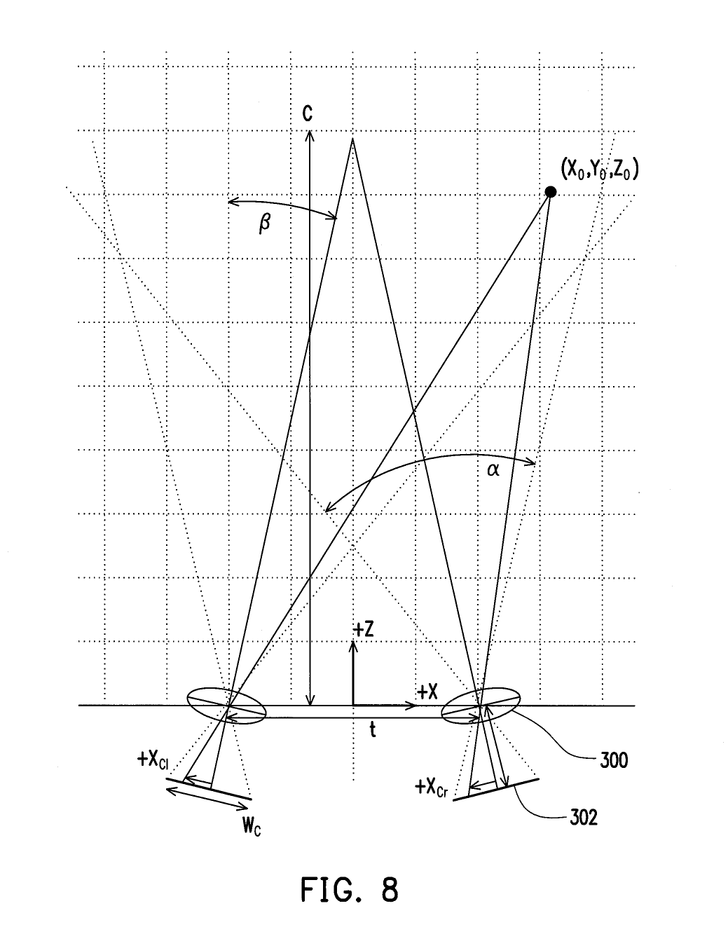

Below, how the spatial location of the touch tool 210 is detected through the micro image-capturing devices 200 will be described. To detect a 3D location of the touch tool 210, at least two micro image-capturing devices 200 are required to capture images from different angles. In the present embodiment, two micro image-capturing devices 200 are disposed. However the disclosure is not limited thereto, and more micro image-capturing devices 200 may be disposed. FIG. 8 is a diagram illustrating the mechanism of estimating a touch location by two micro image-capturing devices from an image plane according to an embodiment of the disclosure. Referring to FIG. 8, as to the coordinate system XYZ on the holder, the centers of the lenses 300 on the two micro image-capturing devices 200 are kept apart at a distance t. Image sensing devices 302 are disposed behind the lenses 300, wherein the image sensing devices 302 may be charge-coupled devices (CCD).

In order to allow a user to operate with his finger in an unsupported way at a short length z=500 mm and to accomplish virtual tag triggering and dragging through virtual touch operations, a short-distance virtual touch control technique needs to be developed. After images are captured through the lenses 300 and the image sensing devices 302, the location of the user's finger is determined through a stereoscopic vision system. Then, the 3D coordinates (x0, y0, z0) of the user's finger is determined by using the locations (xcl, ycl) and (xcr, ycr) of the user's finger respectively on the two image sensing devices 302. Following expressions (1)-(4) are obtained through geometrical derivation:

$$\begin{matrix}{z}_{0} = \frac{t}{tan [ {tan}^{- 1} ( \frac{{x}_{cl} + h}{f} ) + β ] + tan [ {tan}^{- 1} ( \frac{{x}_{cr} - h}{- f} ) + β ]} ; & ( 1 ) \\ y 0 = \frac{2 \cdot {z}_{0} \cdot cos β + t \cdot sin β}{f \cdot ( \frac{1}{{y}_{cl}} + \frac{1}{{γ}_{cr}} )} ; & ( 2 ) \\ {x}_{0} = {z}_{0} \cdot tan [ {tan}^{- 1} ( \frac{{x}_{cl} + h}{f} ) + β ] - \frac{t}{2} ; & ( 3 ) \\ {x}_{0} = {z}_{0} \cdot tan [ {tan}^{- 1} ( \frac{{x}_{cr} - h}{- f} ) + β ] - \frac{t}{2} , & ( 4 )\end{matrix}$$

wherein t is the distance between the two image sensing devices 302, h is the sensor axial offset of the image sensing devices 302, f is the lens focal length, and β is the lens convergence angle.

The localization range (xy) around the finger can be extended by reducing the lens focal length f of the micro cameras. However, if a larger field of view (FOV) is analyzed by the same CCD pixel (i.e., the FOV is increased), the finger depth localization precision (z) will be reduced. Thus, a micro image-capturing technique has to be adopted in order to achieve a micro lens with both ultra-short focal length and high pixel resolution and to realize long-distance finger localization through short-distance virtual touch operations.

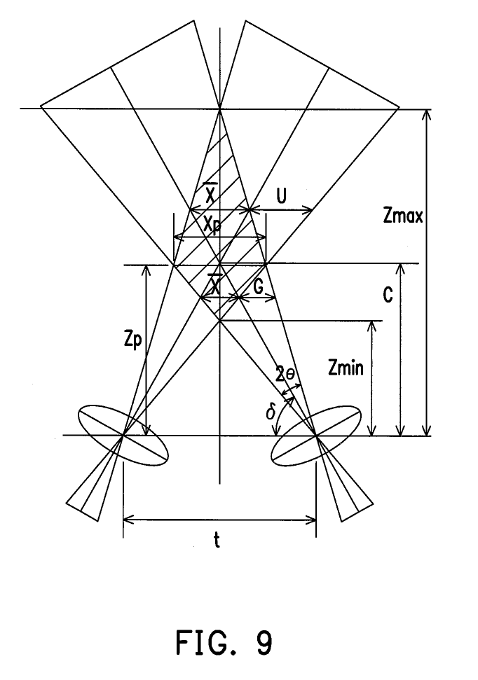

FIG. 9 is a diagram illustrating an effective operation range of long-distance touch operations according to an embodiment of the disclosure. Referring to FIG. 9, the image sensing devices 302 are disposed farther behind the lenses 300. Thus, a plurality of parameters can be obtained through geometrical analysis, and the overlapping area of the two micro image-capturing devices 200 can determined according to these parameters, wherein the overlapping area is the effective range of long-distance touch operations, as the area denoted with diagonal lines. Because the touch operation is performed at a longer distance, the effective touch operation range is smaller.

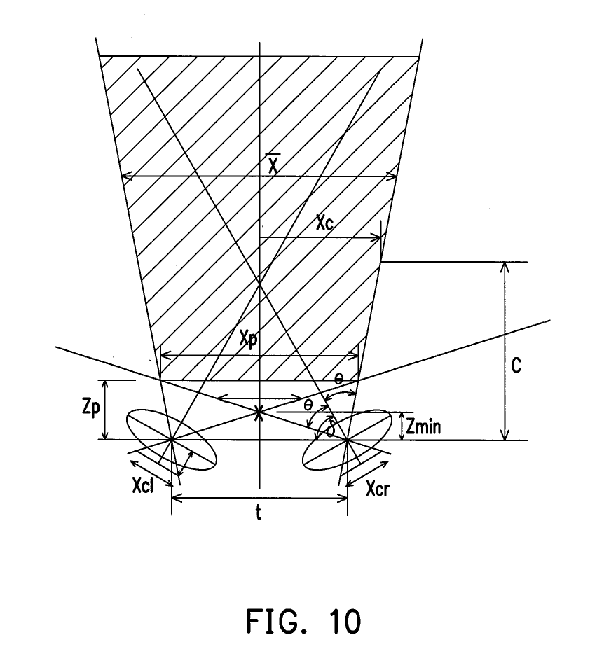

FIG. 10 is a diagram illustrating an effective operation range of short-distance touch operations according to an embodiment of the disclosure. Referring to FIG. 10, if the image sensing devices 302 are disposed close to the lenses 300, a plurality of parameter is also obtained through geometrical analysis, and accordingly the overlapping area of the two micro image-capturing devices 200 is also determined, wherein the overlapping area is the effective range of short-distance touch operations, as the area denoted with diagonal lines, and which is larger than the effective range illustrated in FIG. 9.

Herein it should be noted that because of the geometrical structure of the lenses, all the images captured through the lenses are distorted. Thus, when the images of the touch indicators are produced on the image sensing devices 302 through the lenses, the spatial locations thereof may not be the same if they are directly calculated. As a result, incorrect touch operation may be induced. In an embodiment, the problem of image distortion is resolved through calibration. As shown in FIGS. 9-10, the touch operation range can be obtained through geometrical analysis. A plurality of calibration reference points is obtained within this touch operation range. Each calibration reference point is measured in advance to obtain a measured location. A coordinate offset of the measured location can be obtained based on the actual spatial coordinates of each calibration reference point. Each measured location can be calibrated to an ideal spatial location within the touch operation range according to the calibration data obtained based on the calibration resolution requirement. Thereby, the images and touch tools can all be calibrated to achieve locations very close to their actual locations.

In the disclosure, a virtual touch control technique is achieved by using a stereoscopic visual localization technique, a see-through display device, and a portable I/O embedded platform. Images of a real scene are captured by two micro cameras disposed at both sides of the see-through display device, and a virtual image is displayed through the see-through display device. When the hands of a user enter the working area of the micro cameras, finger images are captured and converted into localization coordinates of the fingers. Herein the virtual image and the localization image of the fingers can be both seen on the see-through display device. A virtual graphing module and a virtual touch control module respectively transmit the virtual image and the localization coordinates of the fingers to a virtual/real image combination module. By repeating a series of image capturing operations and calculations, functions like finger clicking and virtual image dragging can be performed to achieve a virtual touch control technique.

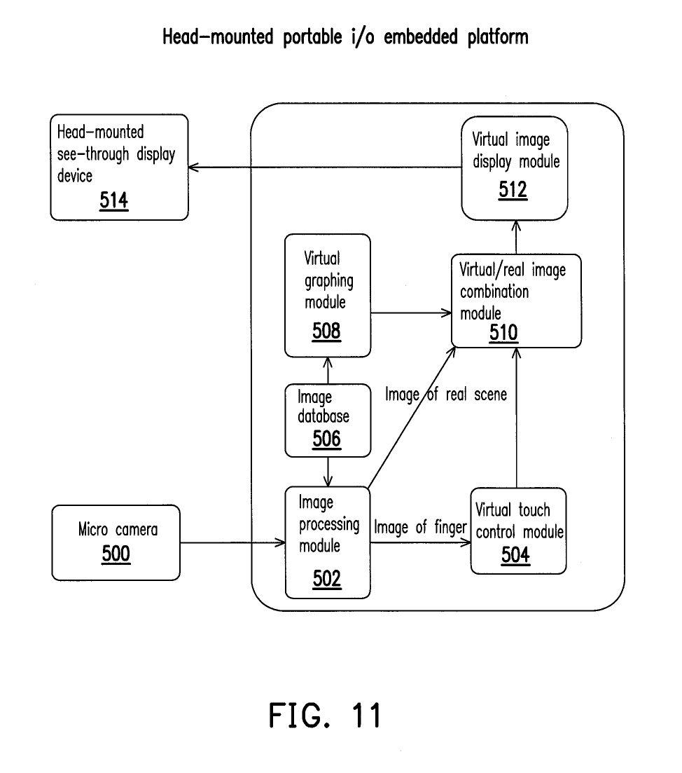

Foregoing functions can be implemented as a portable I/O platform. FIG. 11 is a diagram illustrating the structure of a head-mounted portable input/output (I/O) embedded platform according to an embodiment of the disclosure. Referring to FIG. 11, after capturing the images through the micro image-capturing devices 500, the image processing module 502 converts a image database 506 containing image pre-processing functions into a hardware design through hardware processing, so as to replace the conventional technique in which input images are directly processed by a central processing unit (CPU), so that the image processing efficiency can be effectively improved and the word load of the CPU can be reduced. The virtual graphing module 508 establishes the virtual image by using scene information pre-established in the image database 506. The virtual/real image combination module 510 dynamically tracks the variation of the real scene based on the previous image of the real scene. Meanwhile, the virtual/real image combination module 510 quickly obtains the coordinates of the virtual image through feature transform with unchanged image size. The virtual image display module 512 drives the head-mounted see-through display device 514 to display the virtual image according to the virtual image coordinates (for example, virtual tags) received from the virtual/real image combination module 510. The virtual touch control module 504 converts the finger image received by the micro image-capturing devices 500 into the localization coordinates of the finger and determines the touch location on the image displayed by the head-mounted see-through display device 514, so as to provide a touch control display.

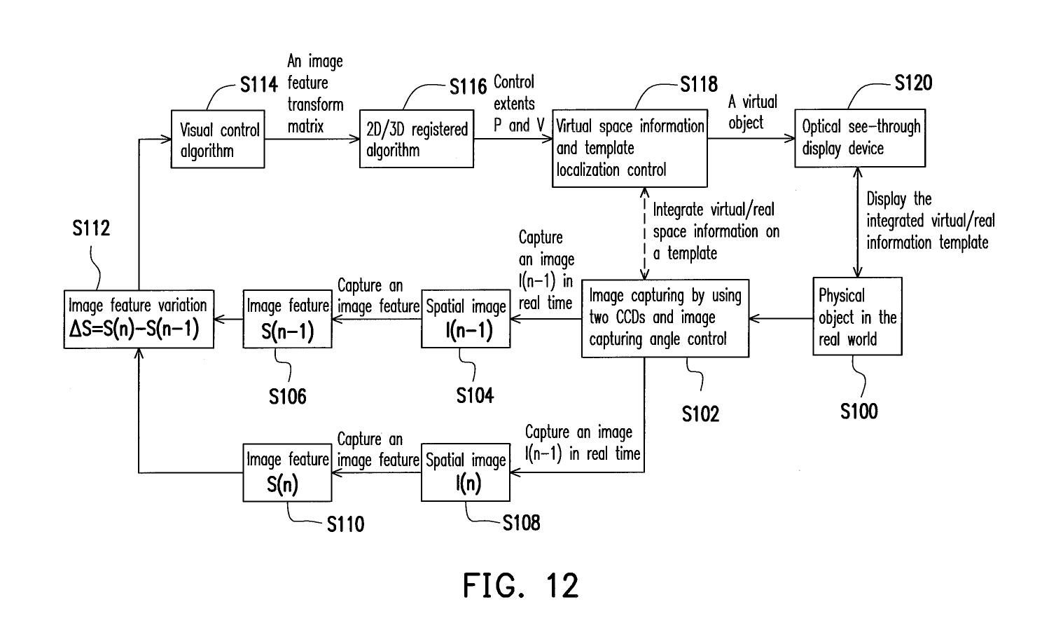

The operation of the portable I/O platform can be achieved through several steps. FIG. 12 is a diagram illustrating a dynamic real-virtual control procedure according to an embodiment of the disclosure. Referring to FIG. 12, in step S100, a physical object in the real world is adopted as a target. In step S102, images of the object are captured by using two CCDs, and the image capturing angles are controlled to output an image I(n−1) captured in real time, wherein n−1 represents an image captured previously. In step S104, the image I(n−1) is converted into a spatial image, and image features are captured. In step S106, an image feature S(n−1) is determined. In step S102, a current image I(n) is captured in real time. In step S108, the image I(n) is converted into a spatial image. In step S110, an image feature S(n) is determined. In step S112, an image feature variation analysis is performed on the image features S(n) and S(n−1) obtained in steps S110 and S106. In step S114, an image feature transform matrix is obtained through a visual control algorithm according to the result of the image feature variation analysis. In step S116, the desired control extent is obtained through a 2D/3D registered algorithm. In step S118, virtual space information and template localization control are performed, and the template is overlapped with the physical space obtained in step S102 to output a virtual object. In step S120, a user is allowed to see the physical object in the real world and the virtual object at the same time through an optical see-through display device. Thereby, the virtual/real information of the physical object and the virtual object are integrated on the template to be displayed together.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A virtual touch system, comprising:
a see-through display device, having a holder and an optical lens group, wherein the optical lens group allows an image light of a real scene to directly pass through and reach an observing location;
a micro-image display, disposed on the holder, for casting a display image to the observing location through the optical lens group to generate a virtual image plane, wherein the virtual image plane comprises a digital information;
at least two micro image-capturing devices, disposed at the holder, for capturing images of the real scene and a touch indicator; and
an image processing unit, coupled to the head-mounted see-through display device, for recognizing the touch indicator and calculating a relative location of the touch indicator on the virtual image plane for the micro-image display.

2. The virtual touch system according to claim 1, wherein the digital information of the virtual image plane comprises a touch information, and a touch operation is executed according to the relative location of the touch indicator.

3. The virtual touch system according to claim 2, wherein the touch information comprises a touch option.

4. The virtual touch system according to claim 2, wherein the touch information comprises a virtual input keyboard.

5. The virtual touch system according to claim 1, wherein the micro image-capturing devices are coupled to an external network information system, and the external network information system provides the corresponding digital information according to the captured image of the real scene.

6. The virtual touch system according to claim 1, wherein the virtual image plane overlaps the real scene at the observing location.

7. The virtual touch system according to claim 1, wherein the micro image-capturing devices are disposed in a staggered way to capture images of the touch indicator from different angles, and the image processing unit determines a 3D coordinate of the touch indicator.

8. The virtual touch system according to claim 1, wherein the micro image-capturing devices are disposed in a staggered way to form an effective image capturing space image capturing space, and the image processing unit comprises a location calibration information for calibrating the captured images of the real scene and the touch indicator back to a predetermined actual location in the image capturing space.

9. The virtual touch system according to claim 1, wherein the image processing unit also calculates a relative location of the real scene on the virtual image plane.

10. The virtual touch system according to claim 1, wherein the image processing unit calculates coordinates of the real scene on an image sensing plane of the micro image-capturing devices and then on the virtual image plane.

11. The virtual touch system according to claim 1, wherein the optical lens group has a light guide structure for guiding and casting the display image of the micro-image display to the observing location.

12. The virtual touch system according to claim 1, wherein the observing location is two eyes of a user.

13. The virtual touch system according to claim 1, wherein a number of the micro image-capturing devices is two, and the micro image-capturing devices are respectively disposed on a left frame and a right frame of the holder.

14. The virtual touch system according to claim 1, wherein the micro image-capturing devices further capture images of the real scene, and the image processing unit determines a depth information of the real scene.

15. A virtual touch system, comprising:
a see-through display device, having a holder and an optical lens group;
a micro-image display, disposed on the holder, for casting a display image to an observing location through the see-through display device to generate a virtual image plane, wherein the virtual image plane comprises a touch control digital information;
at least two micro image-capturing devices, disposed at the holder, for capturing images of a touch indicator; and
an image processing unit, coupled to the see-through display device, for recognizing the touch indicator and calculating a relative location of the touch indicator on the virtual image plane for the micro-image display, so as to display the touch control digital information.

16. The virtual touch system according to claim 15, wherein the touch control digital information comprises a display image and a touch option for controlling the display image.

17. The virtual touch system according to claim 15, wherein the touch control digital information comprises a display image and a virtual input keyboard for controlling the display image.

18. The virtual touch system according to claim 15, wherein the see-through display device is head-mounted.
